(19) United States
(12) Patent Application Publication
(10) Pub. No.: US 2013/0297537 A1
(43) Pub. Date: Nov. 7, 2013

(54) Method and System for creating Dynamic Neural Function Libraries

(71) Applicant: Peter AJ. van der Made, Gosnells (AU)

(72) Inventor: Peter AJ. van der Made, Gosnells (AU)

(21) Appl. No.: 13/461,800

(22) Filed: May 2, 2012

(51) Int. Cl. G06F 15/18

(52) U.S. Cl. 706/12

(57) ABSTRACT

The current invention comprises a function library and relates to Artificial Intelligence systems and devices. Within a Dynamic Neural Network (the “Intelligent Target Device”) training model values are autonomously generated in during learning and stored in synaptic registers. One instance of an Intelligent Target Device is the “Autonomous Learning Dynamic Artificial Neural Computing Device and Brain Inspired System”, described in patent application number 20100076916 and referenced in whole in this text. A collection of values that has been generated in synaptic registers comprises a training model, which is an abstract model of a task or a process that has been learned by the intelligent target device. A means is provided within the Intelligent Target Device to copy the training model to computer memory. A collection of such training model sets are stored within a function library on a computer storage facility, such as a disk, CD, DVD or other means.

The present invention relates to a method of accessing learned functions in an intelligent target device, such as the “Autonomous Learning Dynamic Artificial Neural Computing Device and Brain Inspired System” referenced in patent application number 20100076916 and, in particular to a method of accessing value sets, representing learned functions, held in a function library in a computing device. The present invention also relates to an intelligent target device controlled by the method.

The term computing device as used herein is to be widely construed to cover any form of electrical device and includes microcontrollers and wired information devices.

The intelligent target device operates under the control of an operating device. The operating device can be regarded as the values that are stored in synaptic registers. The stored control values determine the behavior of individual processing nodes of the intelligent target device. The control values are autonomously generated by the intelligent target device.

The intelligent target device learns autonomously from an input stream that is generated by one or more sensory devices, and modifies values in synaptic registers that determine the behavior of a processing node. The output of the processing node is a pulse, or a sequence of pulses, which represent the integrated time relationship between input pulses, and stored values that represent the learned timing sequence and relative positioning of previously received pulses. The timing sequence and relative positioning represents temporal-spatial patterns in the input stream, expressed as values in synaptic registers. The contents of synaptic registers comprise control values. The Dynamic Neural Function Library contains sets of such control values, representing learned tasks.

Each learned task is a precious resource. Especially complex tasks, such as the recognition of objects or human speech, can take a long time to evolve through learning. Constructing such complex tasks on simpler task training models that are uploaded from a library helps to shorten training time, as well as creating a more structured hierarchical approach to training the Intelligent Target Device

Human knowledge is hierarchical in nature, in which complex knowledge is layered on top of simpler, more basic knowledge. Before a child can learn to speak, it needs to be able to understand spoken words. Spoken words consist of phonemes, which consist of consonants and vowels, which consist of specific frequencies. A child therefore learns in early infancy to recognize frequencies, then learns to recognize specific sounds representing vowels and consonants. Subsequently the child learns to recognize phonemes and eventually whole words and words in context in sentences. The child learns to associate words with objects, to associate between information received by the auditory cortex and information received by the visual cortex.

The information stored in an Intelligent Target Device is similarly hierarchical in nature, consisting of training models that define aspects of a learned function. Complex training models are created by uploading and combining the training models of simpler functions. Further training builds this patchwork of functionality into a consistent model and an autonomously fashioned hierarchy.

Diverse manufacturers using Dynamic Neural Network technologies, such as the Intelligent Target Device, may produce training sets consisting out of values autonomously formed in synaptic registers, and representing learned real world events. Real world events are encoded by various sensory devices as sequences of timed pulses. The values that are subsequently stored in synaptic registers are representative of the timing of these pulses and their relationship in time to one another.

Notwithstanding that a particular training set is unique, a consistent hardware platform such as the afore mentioned Intelligent Target Device allows the training value sets of diverse manufacturers to be combined and to be used on another Intelligent Target Device, particularly where the amount of dynamic neural nodes or the quantity of synaptic registers are different between the two devices.

Certain functions that are present in the hierarchy are likely to be common to multiple applications. To augment the efficient use of device training resources, the values representing these autonomously learned functions within the Intelligent Target Device are accessed and stored in a library on a computing device

The method that is described here comprises a function library, in that it contains functions that are performed by an automated system. However, contrary to the functions that are stored in a Dynamic Link Library, these functions are not called from computer programs. The function is comprised of values that are representative of temporal-spatial patterns that have been learned by an Intelligent Target Device and have been recorded by reading the synaptic registers of such a device. The Intelligent Target Device is not programmed. In its place it learns to recognize temporal-spatial patterns in sensory input streams from exposure to such streams.

### BRIEF DESCRIPTION OF DRAWINGS

FIG. 1, labeled “Method of Reading and Writing Dynamic Neuron Training Models”, represents a preferred embodiment of the function model library creation and uploading method. The communication module reads registers and provides an access means to an external computer system. The communication module is typically a microcontroller or microprocessor or equivalent programmable device. Its “Databus” comprises a method of communicating with the hardware of the dynamic neuron array to receive or send data to binary registers. Neuron numbers 0 to n contain registers that may be read or written to under program control. The lines marked A0 . . . An represent address lines, used to point at a specific synaptic register within the neuron matrix to read or write. The line marked _RD indicates that a READ operation is to be performed, retrieving data from the dynamic neuron matrix. The line marked _WE indicates that a WRITE operation is to be performed and that the data present on the DATABUS is to be written to the register that is addressed by lines A0 to An. The line marked CLOCK (CLKOUT) is a timing signal that determines the speed at which events take place in the Dynamic Neural Network. The operation of reading and writing DATA through the DATABUS, under control of the Address lines A0 . . . An, and the _RD or _WE signals, works independent of the Dynamic Neuron function, which receives pulse information from sensory devices. The lines marked “Synapse INPUTS” receive a pulse pattern as indicated under “Synapses In” in FIG. 1, and produce an output pattern that is relative to this input and previous occurrences of similar input patterns. The Dynamic Neuron function learns to recognize pulse trains that occur in time and in relation to one another, in the manner as described in detail in patent application number 20100076916. Sequences of input pulses of a specific time relationship train the Dynamic Neural Network and produce values in registers that are addressed by address lines A0 . . . An. A large number of such register values comprise a training model. In a typical device 10,000-15,000 Dynamic Neurons comprise a single column. A typical library entry is comprised of, but not limited to, the register values read from one entire column.

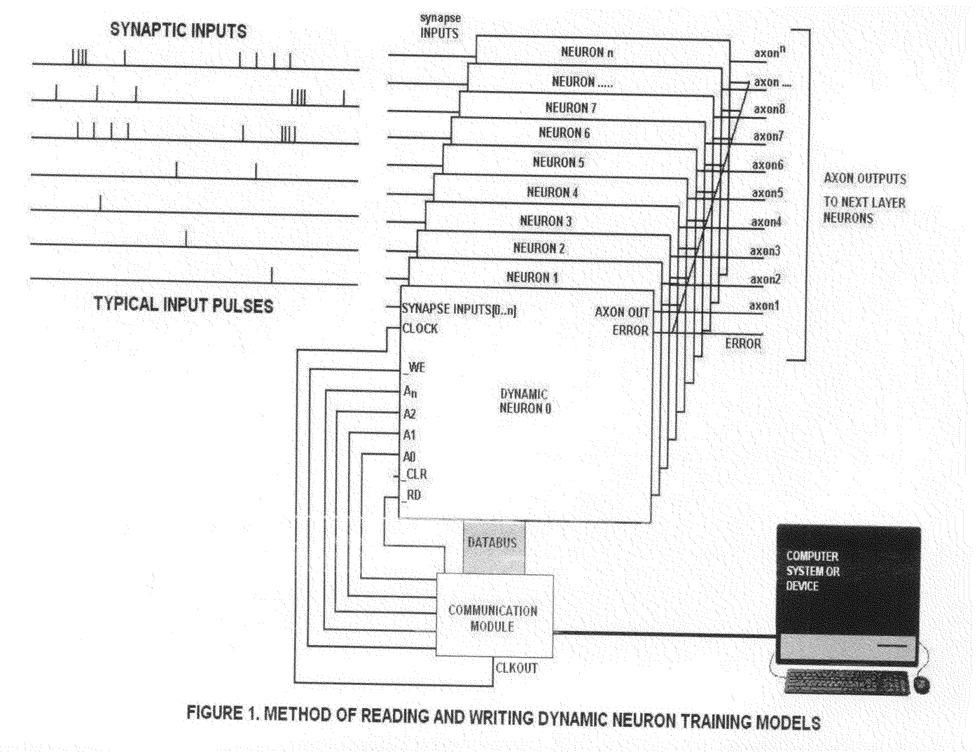

### DESCRIPTION

The present invention relates to a method of accessing learned functions in an intelligent target device, such as the “Autonomous Learning Dynamic Artificial Neural Computing Device and Brain Inspired System” referenced in patent application number 20100076916 and, in particular to a method of accessing value sets, representing learned functions, held in a function library in a computing device. The present invention also relates to an intelligent target device controlled by the method.

The term computing device as used herein is to be widely construed to cover any form of electrical device and includes microcontrollers and wired information devices.

The intelligent target device operates under the control of an operating device. The operating device can be regarded as the values that are stored in synaptic registers. The stored control values determine the behavior of individual processing nodes of the intelligent target device. The control values are autonomously generated by the intelligent target device.

The intelligent target device learns autonomously from an input stream that is generated by one or more sensory devices, and modifies values in synaptic registers that determine the behavior of a processing node. The output of the processing node is a pulse, or a sequence of pulses, which represent the integrated time relationship between input pulses, and stored values that represent the learned timing sequence and relative positioning of previously received pulses. The timing sequence and relative positioning represents temporal-spatial patterns in the input stream, expressed as values in synaptic registers. The contents of synaptic registers comprise control values. The Dynamic Neural Function Library contains sets of such control values, representing learned tasks.

Each learned task is a precious resource. Especially complex tasks, such as the recognition of objects or human speech, can take a long time to evolve through learning. Constructing such complex tasks on simpler task training models that are uploaded from a library helps to shorten training time, as well as creating a more structured hierarchical approach to training the Intelligent Target Device

Human knowledge is hierarchical in nature, in which complex knowledge is layered on top of simpler, more basic knowledge. Before a child can learn to speak, it needs to be able to understand spoken words. Spoken words consist of phonemes, which consist of consonants and vowels, which consist of specific frequencies. A child therefore learns in early infancy to recognize frequencies, then learns to recognize specific sounds representing vowels and consonants. Subsequently the child learns to recognize phonemes and eventually whole words and words in context in sentences. The child learns to associate words with objects, to associate between information received by the auditory cortex and information received by the visual cortex.

The information stored in an Intelligent Target Device is similarly hierarchical in nature, consisting of training models that define aspects of a learned function. Complex training models are created by uploading and combining the training models of simpler functions. Further training builds this patchwork of functionality into a consistent model and an autonomously fashioned hierarchy.

Diverse manufacturers using Dynamic Neural Network technologies, such as the Intelligent Target Device, may produce training sets consisting out of values autonomously formed in synaptic registers, and representing learned real world events. Real world events are encoded by various sensory devices as sequences of timed pulses. The values that are subsequently stored in synaptic registers are representative of the timing of these pulses and their relationship in time to one another.

Notwithstanding that a particular training set is unique, a consistent hardware platform such as the afore mentioned Intelligent Target Device allows the training value sets of diverse manufacturers to be combined and to be used on another Intelligent Target Device, particularly where the amount of dynamic neural nodes or the quantity of synaptic registers are different between the two devices.

Certain functions that are present in the hierarchy are likely to be common to multiple applications. To augment the efficient use of device training resources, the values representing these autonomously learned functions within the Intelligent Target Device are accessed and stored in a library on a computing device

The method that is described here comprises a function library, in that it contains functions that are performed by an automated system. However, contrary to the functions that are stored in a Dynamic Link Library, these functions are not called from computer programs. The function is comprised of values that are representative of temporal-spatial patterns that have been learned by an Intelligent Target Device and have been recorded by reading the synaptic registers of such a device. The Intelligent Target Device is not programmed. In its place it learns to recognize temporal-spatial patterns in sensory input streams from exposure to such streams.

### Prior Art

Function libraries have been used in computer programs for some time. Dynamic Link libraries are extensive used in computer programs today. A Dynamic Link Library provides external functionality to computer programs through the substitution of call addresses. In addition to Dynamic Link Libraries, programming libraries provide source code or machine code that the programmer can include in programs. In such cases the functions are called directly and are included in the object code when the program is compiled. Specific programming libraries for Artificial Intelligence applications contain functions, expressed as programming steps, which control certain aspects of the Artificial Intelligence procedure. Each Artificial Intelligence application program is individually coded and no growth path or re-usable code is generated. In learning systems, the learning function is coded as programming steps and limited to a narrow scope within the range of the application program. In contrast, the functions in a Dynamic Neural Function Library are not called from programs and do not comprise program steps. The functions in the Dynamic Neural Function Library are expressed as values which represent temporal-spatial patterns, which represent a function when they are uploaded or combined in an Intelligent Target System. A common hardware platform, specifically designed for the creation of cognitive systems, aids in the creation of a generic growth path. Dynamic Neural Function Libraries complete the creation of a growth path with re-usable and combinable functions.

1. A method of providing a link between an intelligent target device and a computing device, a function learned by an intelligent target device and an application program, the method comprising providing a means to store the collection of values that is representative of a learned function or task residing in the Intelligent Target Device on a storage element in the computing device.

2. A method according to claim 1 wherein the library consists of the training models of multiple learned tasks

3. A method according to claim 1 wherein the indexed or linked library functions are combined to form more complex functions

4. A method of providing a link between a computing device and an intelligent target device, wherein a function is extracted from the indexed or linked function library that is stored on a computing device or system and uploaded to the Intelligent Target Device.

5. A method according to claim 4, whereby multiple functions from the indexed or linked function library are combined and uploaded to the Intelligent Target Device, instantly training that target system to perform a number of tasks.

6. A method according to claim 4, whereby the Intelligent Target Device continues to learn, and add to the complexity of values that represent previously uploaded functions.

7. A method according to claim 4, whereby the Intelligent Target Device autonomously develops a relational association between uploaded function sets
